(19) United States
(12) Patent Application Publication
(10) Pub. No.: US 2011/0008080 A1
(43) Pub. Date: Jan. 13, 2011

(54) IMAGE FORMING APPARATUS AND IMAGE FORMING METHOD

(75) Inventor: Satoshi CHIBA, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/829,855

(22) Filed: Jul. 2, 2010

(30) Foreign Application Priority Data
Jul. 9, 2009 (JP) 2009-162462

(51) Int. Cl. G03G 15/01

(52) U.S. Cl. 399/304

(57) ABSTRACT

An image forming apparatus includes a latent image bearing unit, an exposure unit, a developing unit, a transfer medium, a transfer roller and a detecting unit. A latent image formed on the latent image bearing unit by an exposure unit is developed by the developing unit with a liquid developer, and a developed image on the latent image bearing unit is transferred to a transfer. The transfer roller includes a cylindrical portion with a concaved portion formed in an axis direction of a circumferential surface of the cylindrical portion, and a transfer material supporting member fixed in the concaved portion and wound around a circumferential surface of the cylindrical portion to support a transfer material. The detecting unit is configured and arranged to detect a rotation position of the transfer roller when the transfer medium and the transfer roller come into contact with each other with the transfer material being interposed therebetween.

### CROSS-REFERENCE TO RELATED APPLICATIONS

This application claims priority to Japanese Patent Application No. 2009-162462 filed on Jul. 9, 2009. The entire disclosure of Japanese Patent Application No. 2009-162462 is hereby incorporated herein by reference.

### BACKGROUND

1. Technical Field

The present invention relates to an image forming apparatus and an image forming method for electro-photographs.

2. Related Art

In the related art, there is known a transfer roller of an image forming apparatus which grips transfer materials (JP-A-2000-508280).

### SUMMARY

It has been discovered that when a rotation position of a transfer roller is detected by the transfer roller, stable detection cannot be performed because driving states such as the speed of the transfer roller change depending on whether there is a transfer material in a nip portion between an image carrier and the transfer roller. In addition, when exposure is performed based on a detection signal for a rotation position of a transfer roller, as driving states of the transfer roller change depending on whether there is the transfer material or not, exposure states may be unstable, thereby there have been cases where a position for an image on a transfer material is also unstable.

An advantage of some aspects of the invention is that it provides an image forming apparatus and an image forming method that enables the detection of a rotation position of a transfer roller in a stable state and satisfactory image formation.

According to an aspect of the invention, an image forming apparatus includes a latent image bearing unit, an exposure unit, a developing unit, a transfer medium, transfer roller and a detecting unit. The latent image bearing unit is configured and arranged to bear a latent image. The exposure unit is configured and arranged to form the latent image on the latent image bearing unit. The developing unit is configured and arranged to develop the latent image formed on the latent image bearing unit with a liquid developer to obtain a developed image on the latent image bearing unit. The transfer medium is a member to which the developed image on the latent image bearing unit is transferred. The transfer roller includes a cylindrical portion with a concaved portion formed in an axis direction of a circumferential surface of the cylindrical portion, and a transfer material supporting member fixed in the concaved portion and wound around a circumferential surface of the cylindrical portion to support a transfer material. The detecting unit is configured and arranged to detect a rotation position of the transfer roller when the transfer medium and the transfer roller come into contact with each other with the transfer material being interposed therebetween.

Furthermore, according to the above aspect, the image forming apparatus preferably further includes a second latent image bearing unit configured and arranged to bear a second latent image, a second exposure unit configured and arranged to form the second latent image on the second bearing unit, and a second developing unit configured and arranged to develop the second latent image formed on the second latent image bearing unit with a second liquid developer having a color different from the liquid developer to obtain a second developed image on the second latent image bearing unit. The transfer medium is preferably arranged with respect to the latent image bearing unit and the second latent image bearing unit such that the second developed image is transferred onto the transfer medium onto which the developed image on the latent image bearing unit has been transferred.

Furthermore, according to the above aspect, the image forming apparatus preferably further includes an exposure controlling unit configured to control the exposure unit based on a detection signal of the detecting unit.

Furthermore, according to the above aspect, the image forming apparatus preferably further includes a driving unit configured and arranged to drive the transfer roller, the driving unit including a motor, a state detecting part configured and arranged to detect a state of the driving unit, and a driving controlling part configured to control the driving unit according to a detection signal of the state detecting part.

Furthermore, according to the above aspect, the image forming apparatus preferably further includes a transfer material transporting unit configured and arranged to transport the transfer material based on the detection signal of the detecting unit. The transfer roller preferably includes a gripping member disposed in the concaved portion and configured and arranged to grip the transfer material.

Furthermore, according to the above aspect, the image forming apparatus preferably further includes a gripping member controlling unit configured and arranged to control the operation of the gripping member.

In addition, according to another aspect of the invention, an image forming method includes: forming a latent image on a latent image bearing unit by exposure of an exposure unit; developing the latent image formed on the latent image bearing unit with a liquid developer; transferring a developed image on the latent image bearing unit onto a transfer medium; feeding a transfer material to a transfer nip formed between the transfer medium and a transfer roller includes a transfer material supporting member, which is wound around a circumferential surface of the transfer roller, to transfer the image transferred onto the transfer medium onto the transfer material; and detecting a rotation position of the transfer roller when the transfer roller, and the transfer medium come into contact with each other with the transfer material being interposed therebetween.

Furthermore, according to the above aspect, the image forming method preferably further includes controlling the exposure of the exposure unit based on a detection signal for the rotation position of the transfer roller.

According to the aspects of the invention, the rotation position of the transfer roller can be detected in a stable state when the transfer medium and the transfer roller come into contact with each other with the transfer material interposed therebetween. In addition, since the transfer material is transported based on the stable detection signal, the transfer material can be stably gripped at an appropriate timing.

Furthermore, since the latent image is formed on the latent image carrier based on the detection signal of the detecting unit, it can be matched with the timing of transporting of the transfer material, and an image can be formed at a predetermined position on the transfer material with high accuracy.

In addition, since there is the gripping member controlling unit that controls the operation of the gripping member, the operation of the gripping member can be stably performed at a predetermined position regardless of the speed of the transfer roller.

In addition, since the transfer roller is driven by the motor provided with the driving controlling unit that controls the driving unit according to a state detecting unit, the transfer roller can be stably rotated.

Accordingly, it is possible to provide an image forming apparatus that forms an image satisfactorily.

### BRIEF DESCRIPTION OF THE DRAWINGS

The invention will be described with reference to the accompanying drawings, wherein like numbers reference like elements.

FIG. 1 is a schematic diagram illustrating a configuration of an image forming apparatus according to a first embodiment of the present invention.

FIG. 2 is a perspective view of a secondary transfer roller of the image forming apparatus according to the first embodiment.

FIG. 3 is a cross-sectional diagram of the secondary transfer roller of the image forming apparatus according to the first embodiment.

FIG. 4 is a schematic diagram illustrating a state where a gripper of the secondary transfer roller is closed according to the first embodiment.

FIG. 5 is a schematic diagram illustrating a state where the gripper of the secondary transfer roller is open according to the first embodiment.

FIG. 6 is a schematic diagram illustrating a state where the gripper of the secondary transfer roller is about to grip a transfer material according to the first embodiment.

FIG. 7 is a diagram illustrating a state where the gripper of the secondary transfer roller is gripping the transfer material according to the first embodiment.

FIG. 8 is a schematic diagram illustrating a rotation position detecting unit of the secondary transfer roller according to the first embodiment.

FIG. 9 is a diagram illustrating signal transmission from a rotation position detecting unit according to the first embodiment.

FIG. 10 is a diagram illustrating operation timings of rotation position detection signals and gate rollers according to the first embodiment.

FIG. 11 is a schematic diagram illustrating a state at the point in time 1A in the operation timings shown in FIG. 10 according to the first embodiment.

FIG. 12 is a schematic diagram illustrating a state at the point in time 1B in the operation timings shown in FIG. 10 according to the first embodiment.

FIG. 13 is a schematic diagram illustrating a state at the point in time 1C in the operation timings shown in FIG. 10 according to the first embodiment.

FIG. 14 is a diagram illustrating operation timings of rotation position detection signals, gate rollers, and exposure according to a second embodiment of the present invention.

FIG. 15 is a schematic diagram illustrating a state at the point in time 2A in the operation timings shown in FIG. 14 according to the second embodiment.

FIG. 16 is a schematic diagram illustrating a state at the point in time 2B in the operation timings shown in FIG. 14 according to the second embodiment.

FIG. 17 is a schematic diagram illustrating a state at the point in time 2C in the operation timings shown in FIG. 14 in according to the second embodiment.

### DESCRIPTION OF EXEMPLARY EMBODIMENTS

Hereinafter, exemplary embodiments of the invention will be described with reference to accompanying drawings.

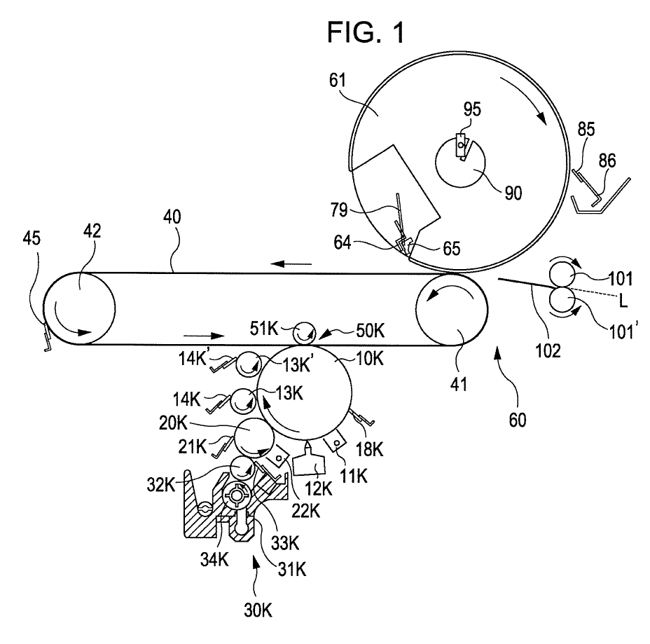

FIG. 1 is a schematic diagram illustrating constituent elements composing an image forming apparatus according to a first embodiment of the present invention. A developing device 30K which is a developing section is arranged at a lower portion of the image forming apparatus than an intermediate transfer belt 40 (one example of a transfer medium) which is arranged in the center portion of the image forming apparatus and is an image carrier or a transfer medium. Other constituent elements such as a secondary transfer section 60 which is a transferring section, a fixing unit (not shown), and the like are arranged in the upper portion of the image forming apparatus.

A corona charger 11K, an exposure unit 12K such as an LED array, and the like are provided around a photoreceptor 10K (one example of a latent image bearing unit) in order to form an image using toner (one example of liquid developer). By uniformly charging the photoreceptor 10K with the corona charger 11K, the exposure unit 12K which is an exposing section performs exposure based on input image signals, and then an electrostatic latent image is formed on the charged photoreceptor 10K.

The developing device 30K is provided roughly with a developing roller 20K which is a developer carrier, a developer container (reservoir) 31K that contains a liquid developer of black color (K), an anilox roller 32K which is a developer supplying member which is a coating roller for coating the liquid developer from the developer container 31K to the developing roller 20K, and the like, and develops an electrostatic latent image formed on the photoreceptor 10K with the liquid developer.

A first transfer section 50K is a section transferring the image formed on the photoreceptor 10K to the intermediate transfer belt 40 via a nip portion between the photoreceptor 10K and a first transfer roller 51K.

The intermediate transfer belt 40 is a seamless belt formed of an elastic member such as rubber or the like, stretched between a belt driving roller 41 and a tension roller 42, and driven and rotated by the belt driving roller 41 while coming into contact with the photoreceptor 10K in the first transfer section 50K. In the first transfer section 50K, the first transfer roller 51K faces the photoreceptor 10K with the intermediate transfer belt 40 being interposed therebetween. The contact point between the photoreceptor 10K and the first transfer roller 51K (via the intermediate transfer belt 40) is a transfer position where a toner image is formed by transferring a developed toner image on the photoreceptor 10K to the intermediate transfer belt 40.

The intermediate transfer belt 40 is wound around the tension roller 42 and the belt driving roller 41, and is stretched therebetween. The tension roller 42 is provided with a cleaning section including a transfer belt cleaning blade 45 in a contacting manner at a point where the intermediate transfer belt 40 is wound around the tension roller 42 to clean remaining toner and carriers on the intermediate transfer belt 40.

The secondary transfer section 60 is provided with a secondary transfer roller 61 (one example of a transfer roller), and the like. The secondary transfer roller 61 rotates in a direction indicated by an arrow in FIG. 1 along the rotation of the belt driving roller 41 while being applied with transfer bias (a bias electric field) so that the toner image of the intermediate transfer belt 40 is transferred to a transfer material such as paper, film, fabric or the like which is fed on a transfer material feeding route L in a transfer nip. In addition, the secondary transfer section 60 includes a transfer roller cleaning blade 85 for cleaning the secondary transfer roller 61, a transfer roller cleaning blade supporting member 86, and the like.

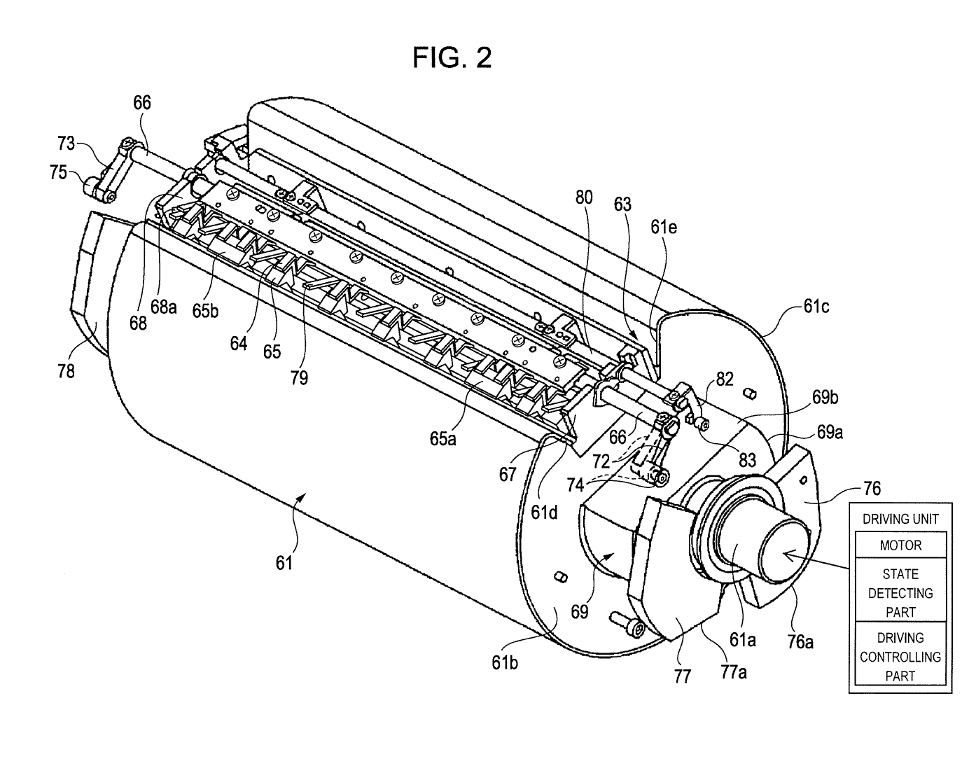

In addition, as shown in FIG. 2, the secondary transfer roller 61 is driven a driving unit including a synchro motor for driving the secondary transfer roller 61, a state detecting part for detecting the state of the motor, and a driving controlling part for controlling the motor according to the state detecting part. The state detecting part detects rotation states of the secondary transfer roller 61 such as the number of rotations, the rotation speed, the rotation position, or the like.

In the downstream of the secondary transfer section 60 on the transfer material feeding route L, a transfer material feeding device (not shown) is arranged so that a transfer material is fed to a fixing unit (not shown). In the fixing unit, a monochromatic toner image transferred onto a transfer material such as paper or the like is fused and fixed thereon.

Supply of a transfer material in the image forming apparatus is performed by a feeding device (not shown). The transfer material set on such a feeding device is transmitted one by one to the transfer material feeding route L at a predetermined timing. On the transfer material feeding route L, the transfer material is fed to the secondary transfer position by a pair of gate rollers 101 and 101′ (one example of a transfer material transporting unit), and a transfer material guide 102, and a monochromatic toner image formed on the intermediate transfer belt 40 is transferred to the transfer material at the secondary transfer position.

The transfer material subjected to secondary transfer is further fed to the fixing unit by the transfer material feeding device as described above. The fixing unit includes a heating roller (not shown) and a pressure roller (not shown) urged with a predetermined pressured on the heating roller side. A transfer material is inserted into the nip between the rollers and a monochromatic toner image transferred onto the transfer material such as paper is fused and fixed thereon.

Hereinafter, the developing device will be described.

Around the photoreceptor 10K, there are provided, using the corona charger 11K as a starting point, with the exposure unit 12K, the developing roller 20K which is a part of the developing device 30K, a first photoreceptor squeeze roller 13K, a second photoreceptor squeeze roller 13K′, the first transfer section 50K, a neutralizing unit (not shown), and a photoreceptor cleaning blade 18K, along the rotation direction of the outer circumference of the photoreceptor 10K. In addition, in an image forming process, the structure where in order from the corona charger 11K to the photoreceptor cleaning blade 18K are arranged toward the front is defined to be in place of the upper stream compared to the structure arranged toward the back.

The photoreceptor 10K is a photoreceptor drum formed of a cylindrical member with a photosensitive layer such as an amorphous silicon photoreceptor, etc. formed on the outer circumferential surface, and rotates clockwise as shown in FIG. 1.

The corona charger 11K is arranged in the upstream side of the nip portion between the photoreceptor 10K and the developing roller 20K in the rotation direction of the photoreceptor 10K, is applied with voltage from a power supply which is not shown and corona-charges the photoreceptor 10K. The exposure unit 12K is arranged in the downstream side of the corona charger 11K and the upstream side of the nip portion between the photoreceptor 10K and the developing roller 20K relative to the rotation direction of the photoreceptor 10K, and radiates light on the photoreceptor 10K charged by the corona charger 11K to form a latent image on the photoreceptor 10K.

Furthermore, the developing device 30K includes the developing roller 20K that supports the liquid developer, the anilox roller 32K that is a coating roller for coating the liquid developer on the developing roller 20K, a regulating blade 33K that regulates the amount of the liquid developer coated on the developing roller 20K, an auger 34K that agitates and transports the liquid developer to supply the anilox roller 32K, a compaction corona generator 22K that makes the liquid developer supported by the developing roller 20K into a compaction state, a developing roller cleaning blade 21K that cleans the developing roller 20K, and the developer container 31K that stores the liquid developer in a state where the toner is dispersed in about 20% ratio by weight in a carrier.

The liquid developer accommodated in the developer container 31K is not a volatile liquid developer with low concentration (about 1 to 3 wt %), low viscosity, and volatility at normal temperature, having ISOPAR (trademark: Exxon) which is generally used in the related art as a carrier, but a non-volatile liquid developer with high concentration, high viscosity, and non-volatility at normal temperature. In other words, the liquid developer of the invention is a liquid developer with high viscosity in which the toner solid content concentration is 15 to 25% (the viscoelasticity is about 30 to 300 mPa·s when the shear velocity at 25° C. is 1000 (1/s) with using HAAKE RHEOSTRESS RS600) and obtained such that solid components with average particle diameter of 1 μm obtained by dispersing a coloring agent such as a pigment in a thermoplastic resin is added to a liquid solvent such as organic solvent, silicon oil, mineral oil, cooking oil or the like with a dispersing agent.

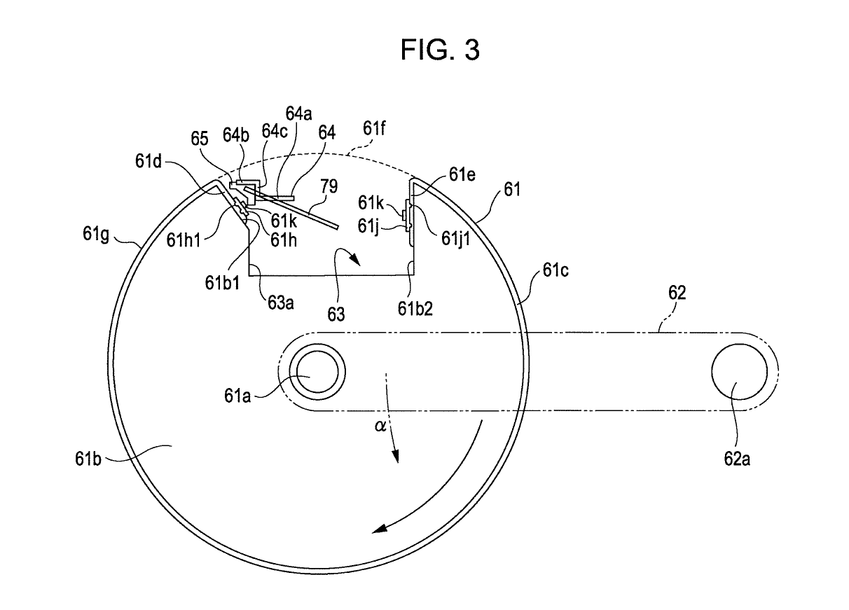

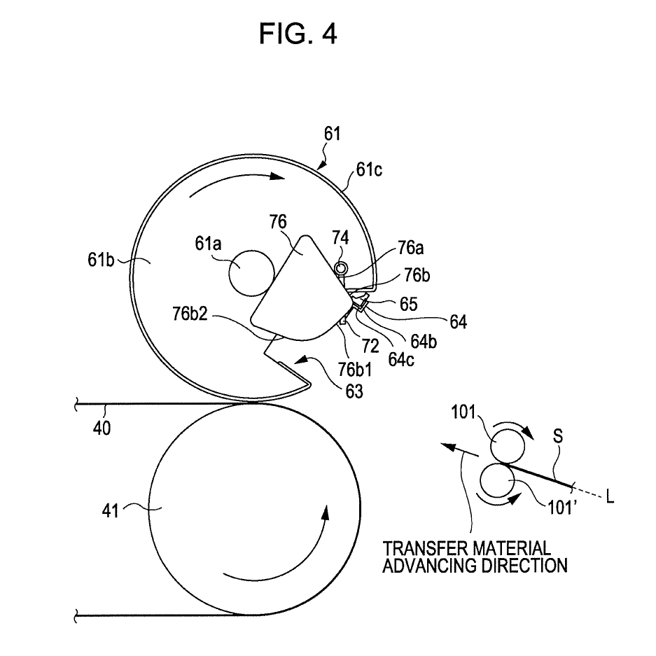

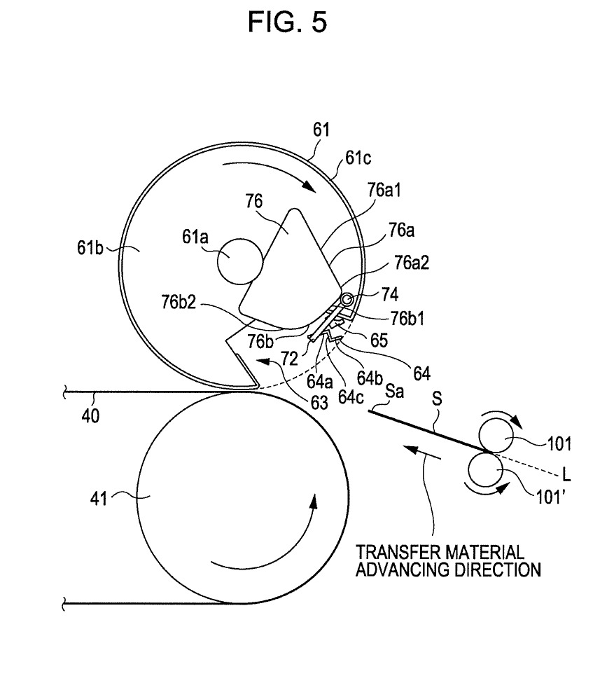

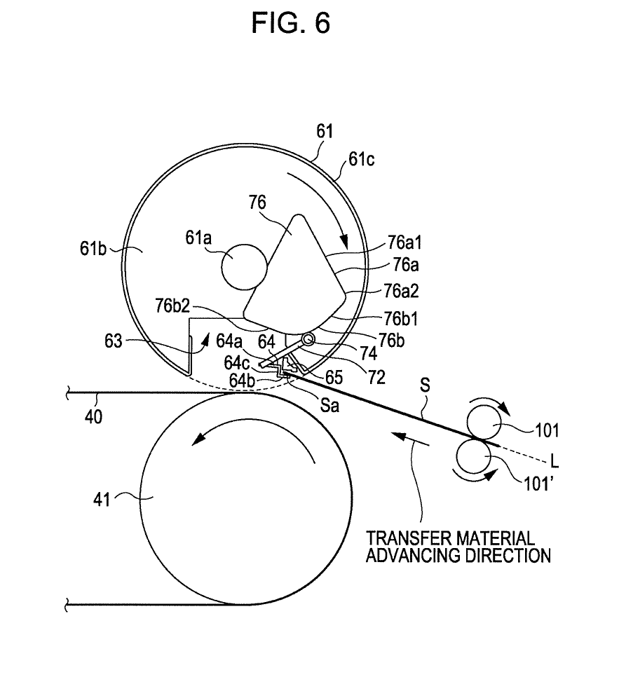

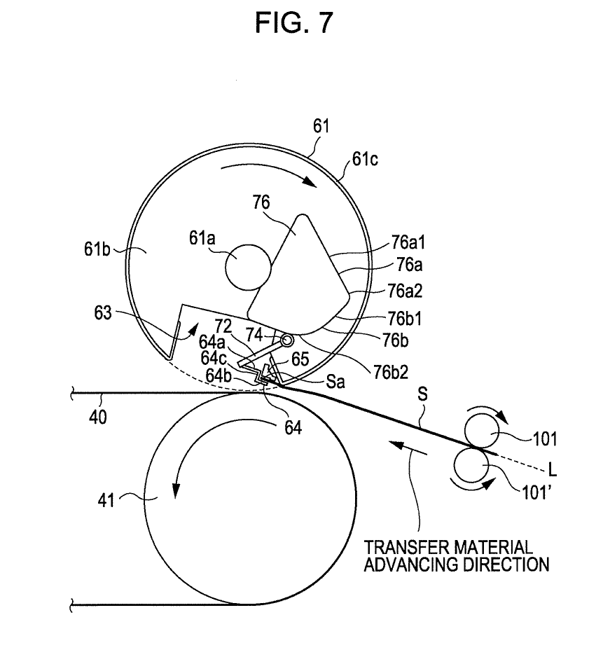

Next, the structure of the secondary transfer roller 61 will be described. FIG. 2 is a perspective view illustrating the secondary transfer roller 61 and FIG. 3 is a schematic cross-sectional view of the secondary transfer roller 61. In addition, FIGS. 4 to 7 illustrate from a state before the secondary transfer roller 61 grips a transfer material S to a state after the secondary transfer roller 61 grips the transfer material S. More specifically, FIG. 4 is a schematic diagram illustrating a state where the secondary transfer roller 61 has not yet gripped the transfer material S, FIG. 5 is a schematic diagram illustrating a state where the transfer material S advances toward the secondary transfer roller 61, FIG. 6 is a schematic diagram illustrating a state where a gripper 64 of the secondary transfer roller 61 is about to grip the transfer material S, and FIG. 7 is a schematic diagram illustrating a state where the gripper 64 of the secondary transfer roller 61 grips the transfer material S.

The secondary transfer roller 61 includes a concaved portion 63 which is a concave portion or a transfer material gripping member accommodating portion. As shown in FIG. 2, the concaved portion 63 extends in the direction of a rotation axis 61a of the secondary transfer roller 61. In addition, the secondary transfer roller 61 has a rubber sheet 61c (one example of a transfer material supporting member) wound around the outer circumferential surface of a circular arc portion of a base material 61b of the secondary transfer roller 61. The rubber sheet 61c forms a resistive layer on the outer circumferential surface of a circular arc portion in the secondary transfer roller 61.

Furthermore, as shown in FIG. 3, edge portions 61d and 61e of the rubber sheet 61c are fixed to the base material 61b at walls 61b1 and 61b2 in the concaved portion 63, and the rest of the rubber sheet 61c is not adhere or fixed to the base material 61b but only wound around the base material 61b. For example, elongated plates 61h and 61j extending in the direction of the rotation axis 61a may be placed on the both edge portions 61d and 61e of the rubber sheet 61c, and may be fastened to the base material 61b with screws 61k, springs, or the like. In addition, the plates 61h and 61j may be each formed with convex portions 61h1 and 61j1 so that the plates 61h and 61j are strongly fixed by the convex portions 61h1 and 61j1 stuck to the rubber sheet 61c. Moreover, the fixation of the both edge portions 61d and 61e of the rubber sheet 61c to the concaved portion 63 is not limited thereto, but other methods may be used.

Furthermore, the rotation axis 61a of the secondary transfer roller 61 is rotatably supported by an arm 62. The arm 62 rotatably swings around the rotation axis 62a supported by the main body of the apparatus (not shown), and is urged in the direction a (counterclockwise in FIG. 1) indicated by the arrow by a spring as a pressing member (not shown). With the urging force of the spring, the secondary transfer roller 61 comes into contact with the belt driving roller 41 with a constant load via the intermediate transfer belt 40.

In the concaved portion 63, a gripper 64 (one example of a gripping member) and a gripper supporting portion 65 (one example of a gripping member supporting portion) where the gripper 64 is positioned are arranged.

Each gripper 64 is formed of a thin strip-shaped metal plate which has the same shape and/or size. The gripper 64 is arranged along the direction of the rotation axis 61a of the secondary transfer roller 61 and may be provided in an arbitrary number. As an example, the gripper 64 is formed by being bent in a crank shape. As shown in FIG. 3, one edge of the gripper 64 is a fixed edge portion 64a fixed to a rotation axis 66 shown in FIG. 2, and the other edge of the gripper 64 is a gripping portion 64b that is selectively abutted against or separated from the gripper supporting portion 65. The gripping portion 64b pinches a leading end Sa of the transfer material S to grip the transfer material S in a gap between the gripper supporting portion 65. Furthermore, the gripper 64 has a step 64c formed between the fixed edge portion 64a and the gripping portion 64b.

As shown in FIG. 2, the gripper supporting portion 65 is arranged along the axis direction of the secondary transfer roller 61 with the same number as that of the number of grippers 64. Such a gripper supporting portion 65 is provided in a side wall 63a of the concaved portion 63, which is disposed in a retarded side in the concaved portion 63 with respect to the rotation direction of the secondary transfer roller 61 as shown in FIG. 3.

Each gripper 64 is fixedly coupled to the rotation axis 66 so as to integrally rotate with the rotation axis 66. Both edges of the rotation axis 66 are rotatably supported by supporting plates 67 and 68 standing in a position that faces the concaved portion 63 so that the rotation axis 66 rotates relative to the secondary transfer roller 61. As shown in FIG. 2, the both edges of the rotation axis 66 pass through the supporting plates 67 and 68, and extend in the direction of the rotation axis 61a of the secondary transfer roller 61.

Each of the edges of the rotation axis 66 passing through the supporting plates 67 and 68 is attached with each of edges of a first gripper controlling arm 72 and a second gripper controlling arm 73, respectively, so that the first and second gripper controlling arms 72 and 72 integrally rotate with the rotation axis 66. The first and second gripper controlling arms 72 and 73 are urged at all times in a direction where the grippers 64 are positioned in the gripper supporting portion 65. The other edges of the first and second gripper controlling arms 72 and 73 are respectively provided with a first gripper controlling cam follower 74 and a second gripper controlling cam follower 75 in roller shapes so that the first and second gripper controlling cam followers 74 and 75 perform relative rotation with the first and second gripper controlling arms 72 and 73, respectively.

As shown in FIG. 2, the secondary transfer section 60 is further provided with a first gripper controlling cam 76 (one example of a gripping member controlling unit) that is preferably fixed to a frame that supports one end of the secondary transfer roller 61 so that the first gripper controlling cam 76 does not rotate. In addition, a second gripper controlling cam (one example of a gripping member controlling unit) which is not shown in FIG. 2 is also preferably fixed to a frame that supports the other end of the secondary transfer roller 61 so that the second gripper controlling cam does not rotate. The first gripper controlling cam 76 and the second gripper controlling cam are formed in the same shape and size and are symmetrically arranged with respect to a straight line orthogonal to a center axis line of the secondary transfer roller 61. The first gripper controlling cam 76 and the second gripper controlling cam control the grippers 64 in conjunction with rotation of the secondary transfer roller 61 so that the grippers 64 grip the leading end Sa of the transfer material S, such as paper, which has been supplied to the secondary transfer section 60, in the gap between the gripper supporting portion 65 during secondary transferring, as shown in FIG. 2.

Furthermore, the secondary transfer section 60 is arranged with a third gripper controlling cam 77 (one example of a gripping member controlling unit) preferably fixedly coupled to the frame that supports one end of the secondary transfer roller 61. In addition, a fourth gripper controlling cam 78 (one example of a gripping member controlling unit) is preferably coupled to the frame that supports the other end of the secondary transfer roller 61. The third and fourth gripper controlling cams 77 and 78 are formed in the same shape and size and are symmetrically arranged with respect to the straight line orthogonal to the center axis line of the secondary transfer roller 61. The third and fourth gripper controlling cams 77 and 78 control the grippers 64 in conjunction with rotation of the secondary transfer roller 61 so that the grippers 64 release the leading end Sa of the transfer material S after the leading end Sa of the transfer material S gripped by each of the grippers 64 passes through a transfer nip. The first to fourth gripper controlling cams are fixed to, for example, the main body of the apparatus, and preferably constitute a gripping member controlling unit.

As shown in FIG. 4, the first gripper controlling cam 76 includes a first gripper controlling cam face 76a and a second gripper controlling cam face 76b. In addition, the first gripper controlling cam follower 74 comes into contact with the first and second gripper controlling cam faces 76a and 76b as the secondary transfer roller 61 rotates.

A cam profile of the first gripper controlling cam face 76a is a straight-lined or substantially straight-lined profile. In that case, the first gripper controlling cam face 76a continues to move away from the center of the rotation axis 61a of the secondary transfer roller 61 starting from a first contact starting portion 76a1, which is a starting side, toward a first release position setting portion 76a2, which is an ending side. At a time when the first gripper controlling cam follower 74 comes into contact with the first contact starting portion 76a1 as a result of rotation of the secondary transfer roller 61, the gripping portion 64b of the gripper 64 is set to a gripping position where the gripping portion 64b is positioned in the gripper supporting portion 65 as shown in FIG. 4. In addition, at a time when the first gripper controlling cam follower 74 is positioned at an end of the first release position setting portion 76a2 as a result of rotation of the secondary transfer roller 61, the gripping portion 64b of the gripper 64 is set to a release position where the gripping portion 64b is the furthest from the gripper supporting portion 65 as shown in FIG. 5.

A cam profile of the second gripper controlling cam face 76b is a curve-shaped profile. In that case, the second gripper controlling cam face 76b has a curve shape of which the curvature radius continuously and gradually is reduced from a first grip starting portion 76b1, which is a starting side of the second gripper controlling cam face 76b, toward a first grip position setting portion 76b2, which is an ending side of the second gripper controlling cam face 76b. At a time when the first gripper controlling cam follower 74 is positioned at the starting end of the first grip starting portion 76b1 as a result of rotation of the secondary transfer roller 61, the gripper 64 is held in the release position as shown in FIG. 6, and at a time when the first gripper controlling cam follower 74 is positioned at the tailing end of the first grip position setting portion 76b2, the gripper 64 is set in the gripping position as shown in FIG. 7.

As for the second gripper controlling cam in the other side, the second gripper controlling cam follower 75 moves on the cam face of the second gripper controlling cam and rotates the gripper controlling arm 73 in the same manner as the first gripper controlling cam follower 74 moves on the cam face of the first gripper controlling cam 76. In addition, as for the third and fourth gripper controlling cams 77 and 78 shown in FIG. 2, the first and second gripper controlling cam followers 74 and 75 move on the cam faces of the third and fourth gripper controlling cams 77 and 78 and rotates the gripper controlling arm 73, thereby operating the gripper 64 so as to control it to be in the gripping state or opening state.

Furthermore, the concaved portion 63 is arranged with a plurality of detaching claws 79 (one example of a detaching member). As shown in FIGS. 2 and 3, the detaching claws 79 are arranged along the direction of the rotation axis 61a of the secondary transfer roller 61. The detaching claws 79 may be provided in an arbitrary number. In addition, the gripper supporting portion 65 is positioned between adjacent detaching claws 79. Each detaching claw 79 is formed of a thin strip-shaped metal plate with the same shape and/or same size. Although not shown, each of the detaching claws 79 is integrally connected with a connecting portion to form a comb shape.

As shown in FIG. 2, each end of the rotation axis 80 penetrating the supporting plates 67 and 68 is installed so that one end of a detaching claw controlling arm 82 integrally rotates with the rotation axis 80. The detaching claw controlling arm 82 is urged by a spring (not shown) at all times in the direction where the detaching claws 79 are in withdrawn or retracted positions. In the other end of the detaching claw controlling arm 82, a roller-shaped first detaching claw controlling cam follower 83 is provided so as to perform relative rotation with the detaching claw controlling arm 82. In the end of the rotation axis 80 penetrating a contacting member 71, a detaching claw controlling arm, which is the same as the detaching claw controlling arm 82, is installed so as to integrally rotate with the rotation axis 80 in the same manner, and urged by a spring at all times. Moreover, in the other end of the detaching claw controlling arm, a second detaching claw controlling cam follower, which is the same as the first detaching claw controlling cam follower 83, is provided so as to perform relative rotation with the detaching claw controlling arm. The first detaching claw controlling cam follower 83 and the second detaching claw controlling cam follower move on the cam faces (not shown) of the first and second detaching claw controlling cams (not shown) and move the detaching claw 79 by rotating the detaching claw controlling arm 82.

The perimeter of the secondary transfer roller 61 is set to be longer than the length of transfer material S, in the moving direction of the transfer material, that has the longest length in the transfer material moving direction among the kinds of the transfer material S used in an image forming apparatus in this embodiment. More specifically, the perimeter of the secondary transfer roller 61 from which a rotation direction width of the concaved portion 63 is excluded is set to be longer than the longest length of the aforementioned transfer material S in the moving direction of the transfer material. Accordingly, a toner image of the intermediate transfer belt 40 is assuredly transferred onto the aforementioned transfer material S which has the longest length in moving direction of the transfer material.

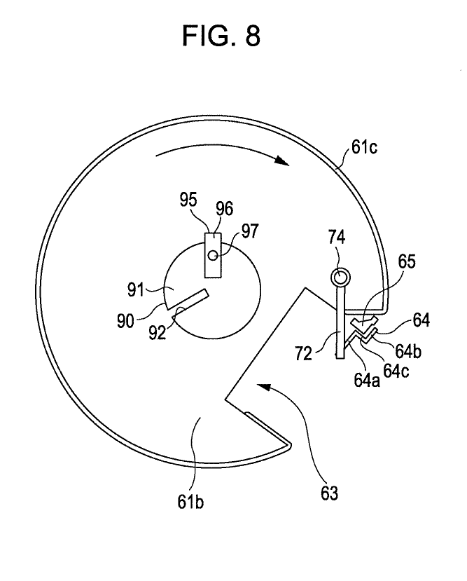

Next, detection of the rotation position of the secondary transfer roller 61 according to an embodiment of the invention will be described. FIG. 8 is a diagram illustrating a rotation position detecting unit.

The secondary transfer roller 61 is provided with a detecting object member 91 that is supported by the same axis 61a as the secondary transfer roller 61 and integrally rotates therewith, and a detecting object unit 90 that has a slit 92 formed in the detecting object member 91.

Furthermore, a rotation position detecting unit 95 is preferably fixedly coupled to a casing or the like (not shown) which supports the secondary transfer roller 61. Although not shown in FIG. 2 for the sake of brevity, the rotation position detecting unit 95 is preferably provided at one of axial end portions of the rotation axis 61a of the secondary transfer roller 61. The rotation position detecting unit 95 includes a sensor supporting member 96, and a sensor 97 that detects the passing of the slit 92. The sensor supporting member 96 includes two arm parts and the detecting object member 91 is interposed between the two arm parts of the sensor supporting member 96 so that the detecting object member 91 rotates with respect to the sensor supporting member 96. The sensor 97 includes a light emitting portion and a light receiving portion that are respectively disposed on the arm parts of the sensor supporting member 96 to face each other via the detecting object member 91. Thus, a timing at which the slit 92 passes is detected when the slit 92 passes between the light emitting portion and the light receiving portion such that the light receiving portion receives light emitted from the light emitting portion.

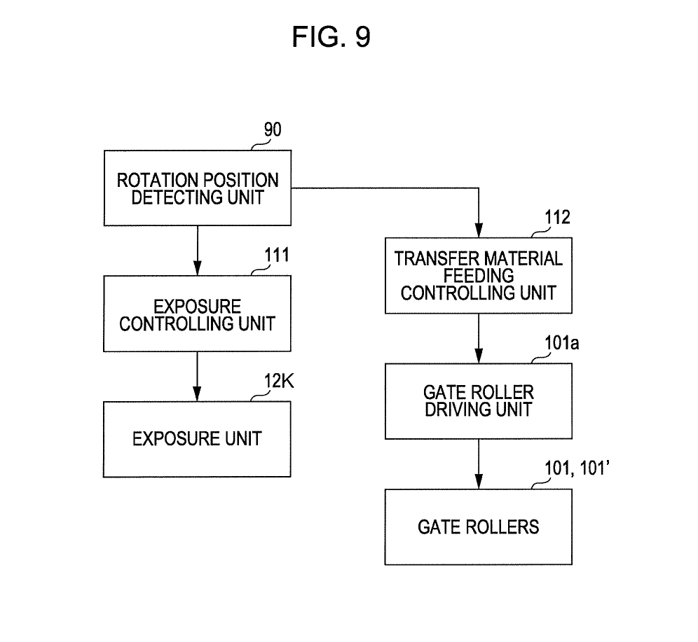

FIG. 9 is a diagram illustrating signal transmission from the rotation position detecting unit. The rotation position detecting unit 95 outputs a signal to an exposure controlling unit 111 and to a transfer material feeding controlling unit 112 when the sensor 97 detects the slit 92. The exposure controlling unit 111 controls exposure timings and outputs an exposure starting signal to the exposure unit 12K when the signal is input from the rotation position detecting unit 95. In addition, the transfer material feeding controlling unit 112 controls feeding timings and outputs a feeding signal to a gate roller driving unit 101a when the signal is input from the rotation position detecting unit 95.

Next, the rotation position detection signal and operation timings of the gate rollers 101 and 101′ according to the first embodiment will be described. In the first embodiment, a timing is set so that the sensor 97 detects the slit 92 when the secondary transfer roller 61 comes into contact with the intermediate transfer belt 40 with the transfer material S interposed therebetween. More specifically, the position of the slit 92 of the detecting object member 91 is arranged with respect to the secondary transfer roller 61 so that the sensor 97 detects the slit 92 when the secondary transfer roller 61 comes into contact with the intermediate transfer belt 40 with the transfer material S interposed therebetween.

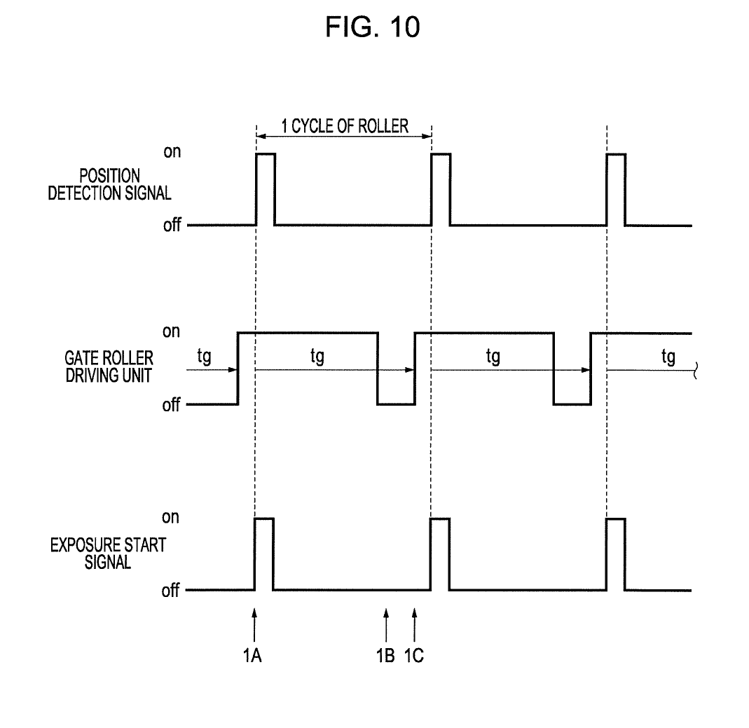

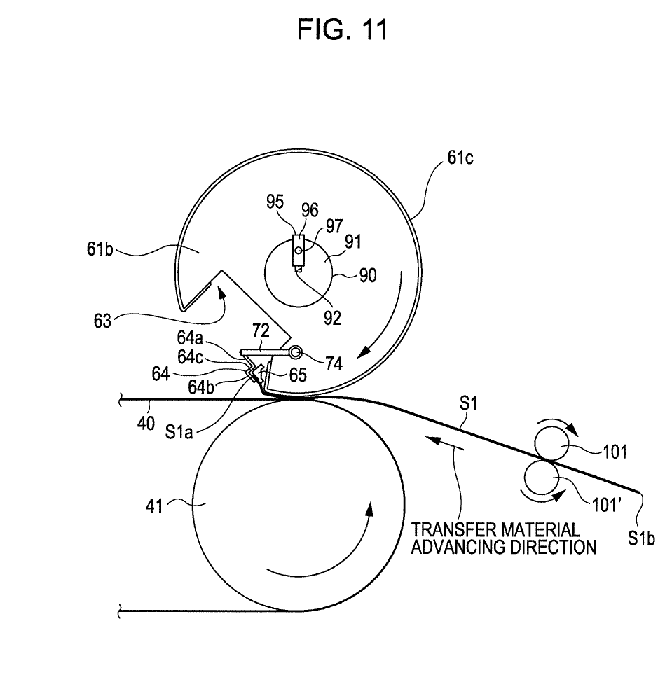

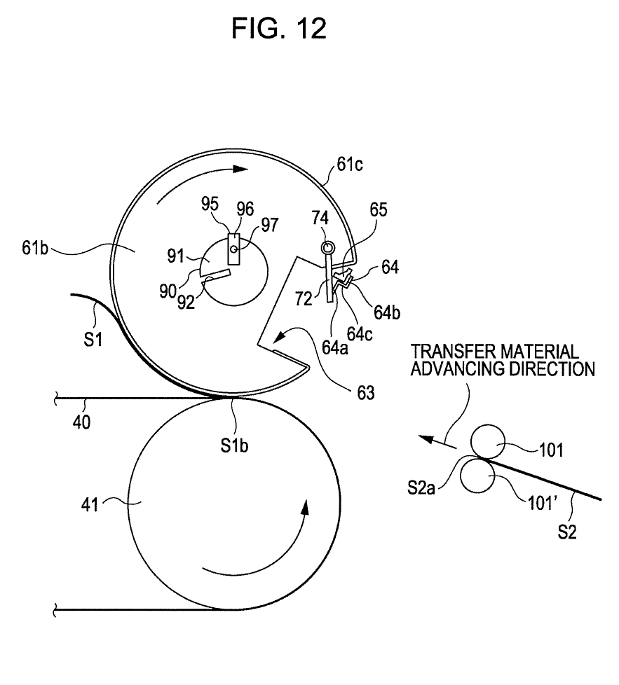

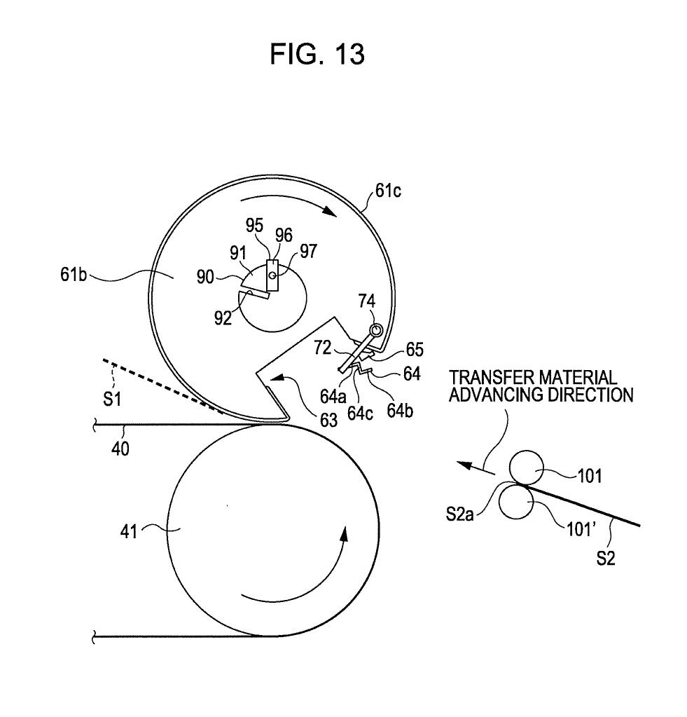

FIG. 10 is a diagram illustrating the rotation position detection signal, operation timings of the gate rollers, and exposure start timings according to the first embodiment, FIG. 11 is a schematic diagram illustrating the state at the point in time 1A in FIG. 10, FIG. 12 is a schematic diagram illustrating the state at the point in time 1B in FIG. 10, and FIG. 13 is a schematic diagram illustrating the state at the point in time 1C in FIG. 10.

As shown in FIG. 11, when the secondary transfer roller 61 rotates and the secondary transfer roller 61 and the intermediate transfer belt 40 come into contact with each other with a transfer material S1 interposed therebetween, the rotation position detection signal of the rotation position detecting unit 95 becomes on as shown in FIG. 10 in a state where the sensor 97 detects the slit 92 (1A in FIG. 10). The transfer material feeding controlling unit 112 shown in FIG. 9 starts counting so that the feeding signal is output to the gate roller driving unit 101a after a predetermined period of time tg when an on signal is input from the rotation position detecting unit 95.

Furthermore, in the state of FIG. 11, the sensor 97 detects the slit 92 when the secondary transfer roller 61 and the intermediate transfer belt 40 come into contact with each other with the transfer material S1 interposed therebetween. As such, since the rotation position detecting unit 95 is arranged so that the sensor 97 detects the slit 92 when the secondary transfer roller 61 and the intermediate transfer belt 40 come into contact with each other with the transfer material S1 interposed therebetween, it is possible to detect the rotation position of the secondary transfer roller 61 in a stable state and an image can be satisfactorily formed by transferring.

After that, as shown in FIG. 12, until a tailing end S1a of the transfer material S1 in a state of passing the nip portion between the secondary transfer roller 61 and the intermediate transfer belt 40 (1B in FIG. 10), an image is transferred from the intermediate transfer belt 40 onto the transfer material S1. In the state of FIG. 12, the gate rollers 101 and 101′ have already stopped the rotation and are waiting for the input of the feeding signal from the transfer material feeding controlling unit 112 in a state of pinching a leading end S2a of the next transfer material S2.

After the time tg (1C in FIG. 10) from the state where the sensor 97 shown in FIG. 11 detects the slit 92, the gate rollers 101 and 101′ start feeding the next transfer material S2 as shown in FIG. 13.

Furthermore, independently of the start-up control of these gate rollers 101 and 101′, the operation of the gripper 64 shown in FIGS. 4 to 7 is synchronized with rotation of the secondary transfer roller 61 by the gripper controlling cams as described above.

According to the first embodiment, the rotation position detecting unit 95 can detect the rotation position of the secondary transfer roller 61 when the circumferential surface of the secondary transfer roller 61 comes into contact with the intermediate transfer belt 40 with the transfer material interposed therebetween, and the transfer material is transported based on the stable detection signal. Therefore, it is possible to grip the transfer material with stability and with an appropriate timing.

Furthermore, since a latent image is formed on the photoreceptor 10K based on the detection signal by the sensor 97, it is possible to match it with the timing of transporting the transfer material, and to form an image at a predetermined position on the transfer material with high accuracy.

Moreover, since the apparatus has independent gripper controlling cams that control the operation of the gripper 64 in conjunction with rotation of the secondary transfer roller 61, it is possible to stably keep the operation of the gripper 64 in a predetermined position regardless of the speed of the secondary transfer roller 61.

Furthermore, since the secondary transfer roller 61 is driven by a motor that can control a driving unit according to a state detecting part, it is possible to stably rotate the secondary transfer roller 61.

### Second Embodiment

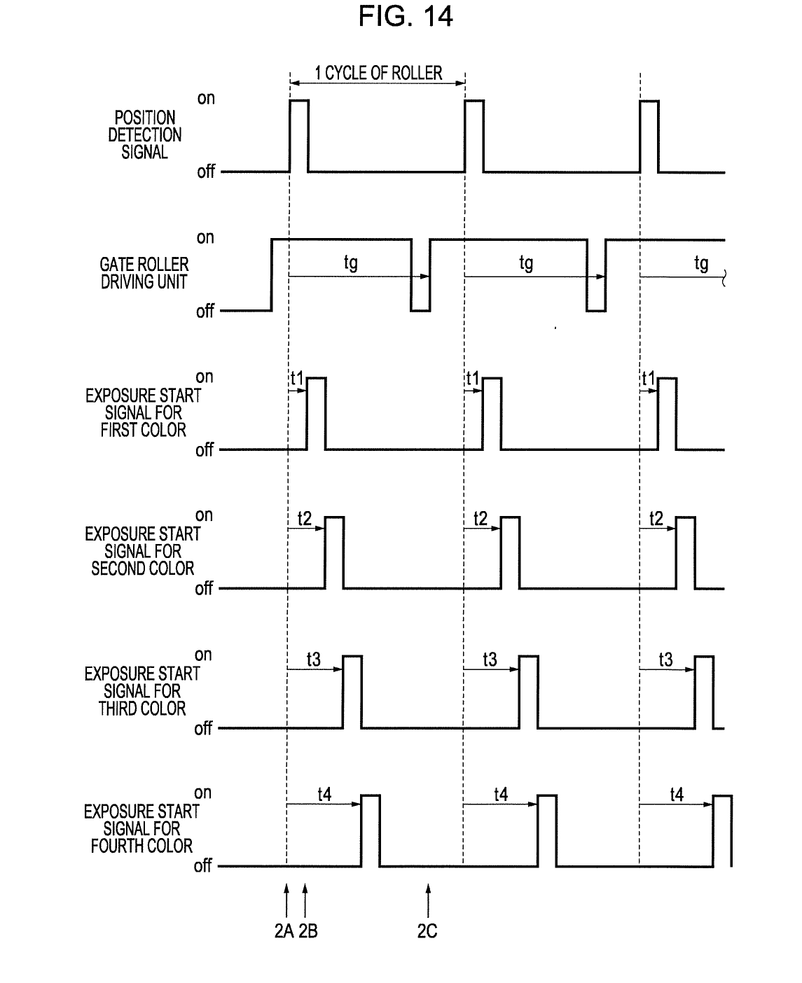

Referring now to FIGS. 14-17, an image forming apparatus in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

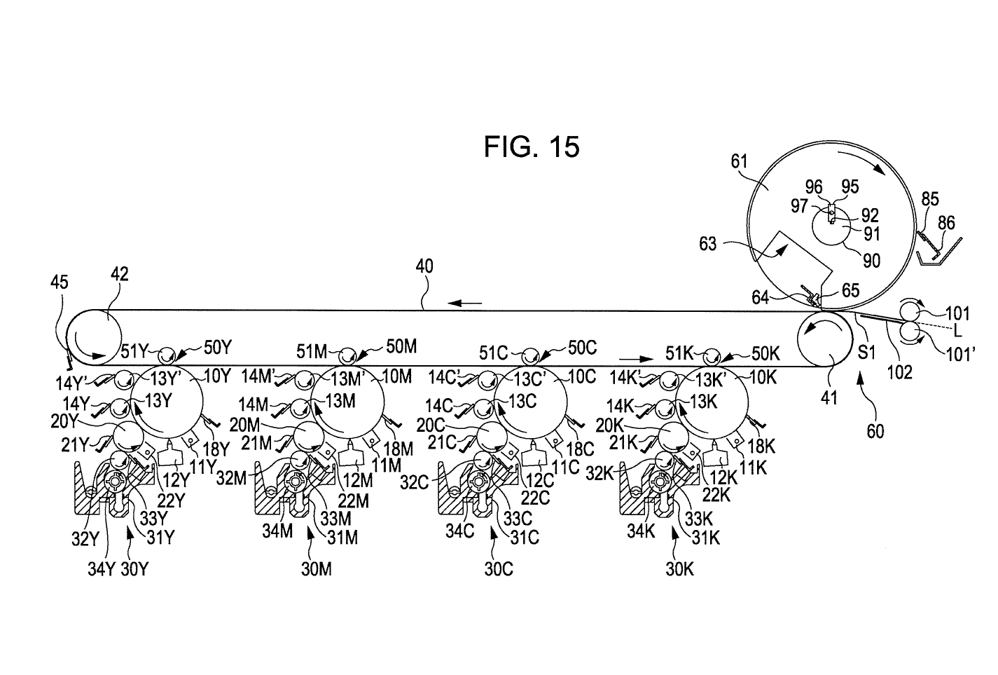

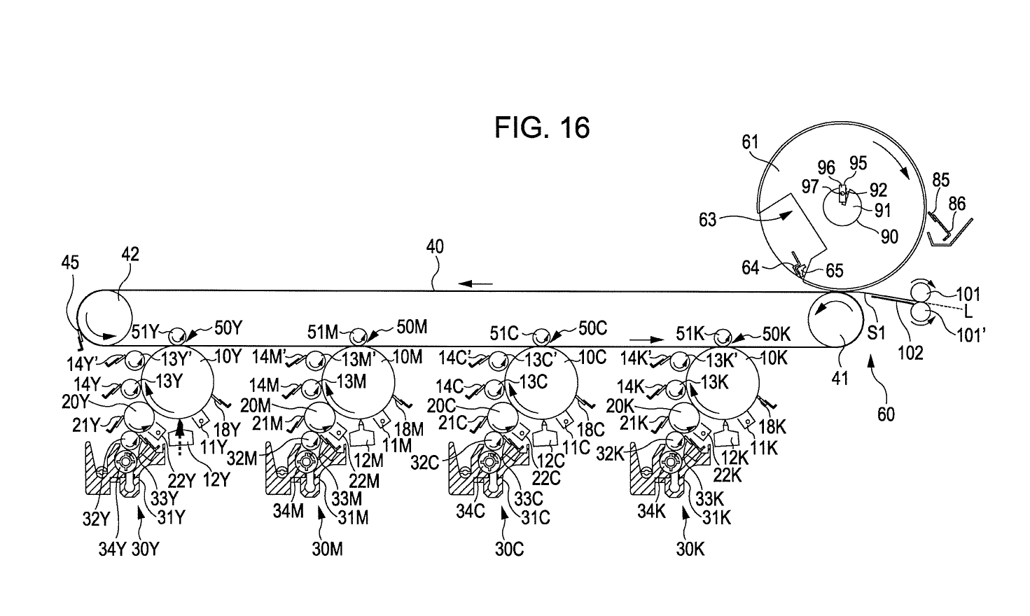

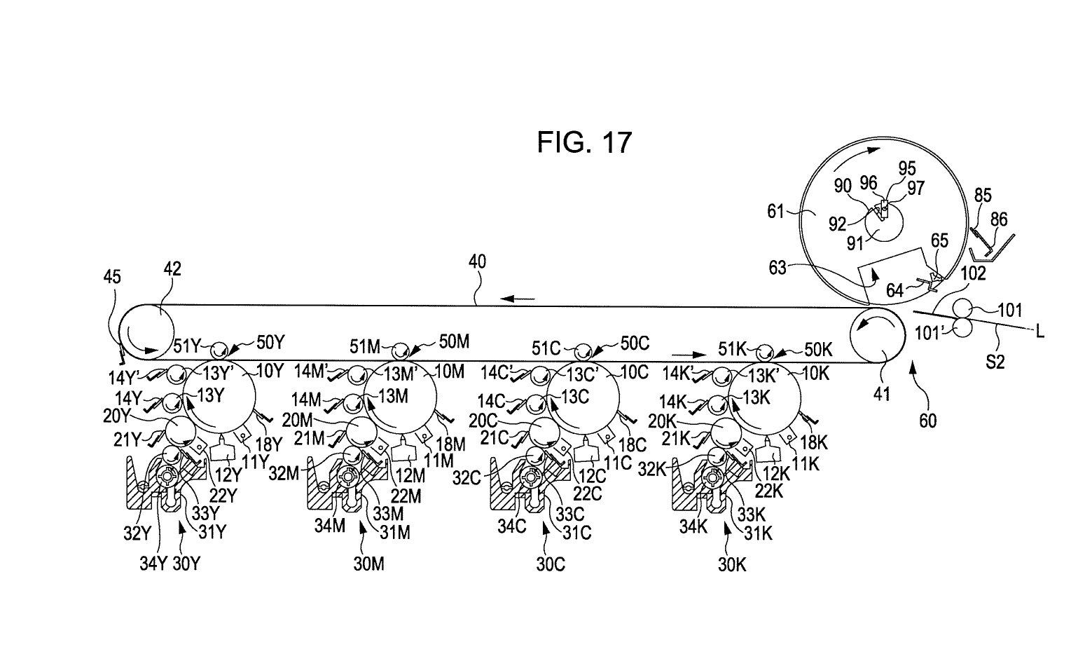

FIG. 14 is a diagram illustrating a rotation position detection signal, operation timings of the gate rollers, and exposure start timings according to the second embodiment, FIG. 15 is a diagram illustrating the state at the point in time 2A in FIG. 14, FIG. 16 is a diagram illustrating the state at the point in time 2B in FIG. 14, and FIG. 17 is a diagram illustrating the state at the point in time 2C in FIG. 14.

The image forming apparatus according to the second embodiment differs from the image forming apparatus of the first embodiment in that the image forming apparatus according to the second embodiment includes a plurality of developing devices 30Y, 30M, 30C, and 30K for four colors are arranged in tandem as shown in FIG. 15. The developing devices 30Y, 30M, 30C, and 30K for four colors are arranged in the order of yellow (Y), magenta (M), cyan (C), and black (K) in order from the far side of the secondary transfer roller 61.

As shown in FIG. 14, the relationship of the rotation position detection signal of the rotation position detecting unit 95 and the operation timing of the gate roller driving unit 101a is the same as that in the first embodiment. As shown in FIG. 15, the sensor 97 detects the slit 92 when the secondary transfer roller 61 comes into contact with the intermediate transfer belt 40 with the transfer material S1 interposed therebetween (2A in FIG. 14). As such, since the sensor 97 is set to detect the slit 92 when secondary transfer roller 61 comes into contact with the intermediate transfer belt 40 with the transfer material S1 interposed therebetween, the rotation position of the secondary transfer roller 61 can be detected in a stable state, and an image can be satisfactorily formed by transferring.

Furthermore, in the second embodiment, description will be provided for a case where exposure by exposure units 12Y, 12M, 12C, and 12K of the developing devices 30Y, 30M, 30C, and 30K for four colors is controlled by the rotation position detecting unit 95.

In the second embodiment, an on signal is input from the rotation position detecting unit 95 to the exposure controlling unit 111, and the exposure units 12Y, 12M, 12C, and 12K, which have had an exposure start signal input from the exposure controlling unit 111, start exposure after predetermined periods of time which are different for each color.

For example, as shown in FIG. 16, the time when the exposure unit 12Y for the first color of yellow (Y) performs exposure is set to t1 after the position detection signal of the rotation position detecting unit 95 becomes on (2B in FIG. 14). In the same manner, exposure start signals input to the exposure unit 12M for the second color of magenta (M), the exposure unit 12C for the third color of cyan (C), and the exposure unit 12K for the fourth color of black (K) are each set to t2, t3, and t4. In the embodiment, since each of the developing devices 30Y, 30M, 30C, and 30K for yellow (Y), magenta (M), cyan (C), and black (K) are arranged in that order from the far side of the secondary transfer roller 61, the exposure start signal for the furthest yellow (Y) is set to be transmitted after the shortest time t1, the exposure start signal for magenta (M) is set to be transmitted after time t2, the exposure start signal for cyan (C) is set to be transmitted after time t3, and the exposure start signal for black (K) is set to be transmitted after time t4, in order from shortest to longest.

After time tg from the state where the sensor 97 shown in FIG. 15 detects the slit 92 (2C in FIG. 14), the gate rollers 101 and 101′ start feeding of the next transfer material S2 as shown in FIG. 17. In FIG. 14, the image, which is obtained by developing the latent image formed with exposure started by using a position detection signal of Rₙ₋₁ as a trigger, is transferred onto the transfer material S that is interposed between the second transfer roller 61 and the intermediate transfer belt 40 when a position detection signal of Rₙ is issued.

Furthermore, independently of the start-up control of these gate rollers 101 and 101′ and the exposure, the operation of the gripper 64 shown in FIGS. 4 to 7 is synchronized with rotation of the second transfer roller 61 by the gripper controlling cams as described above in the first embodiment.

According to the second embodiment, since each color is exposed based on the detection signal of the rotation position detecting unit 95 and the latent image is formed on the photoreceptor 10 for each color, it is possible to match this with the timing of transporting the transfer material, and to form an image at a predetermined position on the transfer material with high accuracy.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image forming apparatus comprising:
a latent image bearing unit configured and arranged to bear a latent image;
an exposure unit configured and arranged to form the latent image on the latent image bearing unit;
a developing unit configured and arranged to develop the latent image formed on the latent image bearing unit with a liquid developer to obtain a image on the latent image bearing unit;
a transfer medium to which the image on the latent image bearing unit is transferred;
a transfer roller including a cylindrical portion with a concaved portion formed in an axis direction of a circumferential surface of the cylindrical portion, and a transfer material supporting member fixed in the concaved portion and wound around a circumferential surface of the cylindrical portion to support a transfer material; and
a detecting unit configured and arranged to detect a rotation position of the transfer roller when the transfer medium and the transfer roller come into contact with each other with the transfer material being interposed therebetween.

2. The image forming apparatus according to claim 1, further comprising
a second latent image bearing unit configured and arranged to bear a second latent image;
a second exposure unit configured and arranged to form the second latent image on the second bearing unit; and
a second developing unit configured and arranged to develop the second latent image formed on the second latent image bearing unit with a second liquid developer having a color different from the liquid developer to obtain a second image on the second latent image bearing unit,
the transfer medium being arranged with respect to the latent image bearing unit and the second latent image bearing unit such that the second image is transferred onto the transfer medium onto which the developed image on the latent image bearing unit has been transferred.

3. The image forming apparatus according to claim 1, further comprising
an exposure controlling unit configured to control the exposure unit based on a detection signal of the detecting unit.

4. The image forming apparatus according to claim 3, further comprising
a driving unit configured and arranged to drive the transfer roller, the driving unit including a motor, a state detecting part configured and arranged to detect a state of the driving unit, and a driving controlling part configured to control the driving unit according to a detection signal of the state detecting part.

5. The image forming apparatus according to claim 3, further comprising:
a transfer material transporting unit configured and arranged to transport the transfer material based on the detection signal of the detecting unit,
the transfer roller including a gripping member disposed in the concaved portion and configured and arranged to grip the transfer material.

6. The image forming apparatus according to claim 5, further comprising
a gripping member controlling unit configured and arranged to control the operation of the gripping member.

7. An image forming method comprising:
forming a latent image on a latent image bearing unit by exposure of an exposure unit;
developing the latent image formed on the latent image bearing unit with a liquid developer;
transferring a image on the latent image bearing unit onto a transfer medium;
feeding a transfer material to a transfer nip formed between the transfer medium and a transfer roller that includes a transfer material supporting member, which is wound around a circumferential surface of the transfer roller, to transfer the image transferred onto the transfer medium onto the transfer material; and
detecting a rotation position of the transfer roller when the transfer roller and the transfer medium come into contact with each other with the transfer material being interposed therebetween.

8. The image forming method according to claim 7, further comprising
controlling the exposure of the exposure unit based on a detection signal for the rotation position of the transfer roller.
